(19) United States
(12) Patent Application Publication
(10) Pub. No.: US 2025/0196690 A1
(43) Pub. Date: Jun. 19, 2025

(54) POWER MANAGEMENT APPARATUS, POWER MANAGEMENT METHOD, STORAGE MEDIUM, AND POWER MANAGEMENT SYSTEM

(71) Applicant: NEC Corporation, Minatu-ku, Tokyo (JP)

(72) Inventors: Hiroaki AMINAKA, Tokyo (JP); Masaru Yanai, Tokyo (JP); Motoharu Ohtake, Tokyo (JP); Hideki Muramatsu, Tokyo (JP); Yoshikatsu Niwa, Tokyo (JP); Noritsugu Yamanaka, Tokyo (JP); Natsumi Yokoyama, Tokyo (JP); Kosei Kobayashi, Tokyo (JP); Hideki Kikkawa, Tokyo (JP); Sawaka Seki, Tokyo (JP)

(73) Assignee: NEC Corporation, Minatu-ku, Tokyo (JP)

(21) Appl. No.: 18/846,484

(22) PCT Filed: Mar. 25, 2022
(86) PCT No.: PCT/JP2022/014368

§ 371 Date: Sep. 12, 2024

(51) Int. Cl. B60L 53/62; B60L 53/66

(52) U.S. Cl. CPC B60L 53/62; B60L 53/665

(57) ABSTRACT

Attained is an object to better control an amount of electric power stored in a target area in which an electric vehicle is electrically charged and discharged. An electric power management apparatus (10) includes: a management section (11) that manages an amount of electric power stored in a target area; and a changing section (12) that causes a parameter associated with a user of an electric vehicle in the target area to undergo a change in accordance with the amount of electric power stored.

### TECHNICAL FIELD

The present invention relates to a technique for managing electric power.

### BACKGROUND ART

A technique for managing electric power is known. For example, Patent Literature 1 discloses a system in which, in a parking lot facility in which an electric vehicle can be electrically charged and discharged, an owner of the electric vehicle is either charged with a fee in accordance with an amount of electrical charging of the electric vehicle or paid a fee in accordance with an amount of electrical discharging of the electric vehicle.

### CITATION LIST

### Patent Literature

### [Patent Literature 1]

Japanese Patent Application Publication Tokukai No. 2021-040403

### SUMMARY OF INVENTION

### Technical Problem

In the technology disclosed in Patent Literature 1, there is a possibility that electrical charging of the electric vehicle is carried out in a state where an amount of electric power stored in the parking lot facility (a target area) is insufficient, or electrical discharging of the electric vehicle is carried out in a state where the amount of electric power stored is excessive. This raises a problem that the amount of electric power stored in the target area cannot be controlled well.

An example aspect of the present invention has been made in view of the above problem, and an example object thereof is to provide a technology that makes it possible to better control an amount of electric power stored in a target area in which an electric vehicle is electrically charged and discharged.

### Solution to Problem

An electric power management apparatus in accordance with an example aspect of the present invention includes: a management means that manages an amount of electric power stored in a target area; and a changing means that causes a parameter associated with a user of an electric vehicle in the target area to undergo a change in accordance with the amount of electric power stored.

An electric power management method in accordance with an example aspect of the present invention includes: managing an amount of electric power stored in a target area; and causing a parameter associated with a user of an electric vehicle in the target area to undergo a change in accordance with the amount of electric power stored.

A program in accordance with an example aspect of the present invention is a program for causing a computer to function as an electric power management apparatus and causes the computer to function as: a management means that manages an amount of electric power stored in a target area; and a changing means that causes a parameter associated with a user of an electric vehicle in the target area to undergo a change in accordance with the amount of electric power stored.

An electric power management system in accordance with an example aspect of the present invention includes an electric power management apparatus and an electric vehicle, the electric power management apparatus including: a management means that manages an amount of electric power stored in a target area; a changing means that causes a parameter associated with a user of the electric vehicle in the target area to undergo a change in accordance with the amount of electric power stored; and a proposal information generation means that generates proposal information for the user in accordance with the amount of electric power stored, the proposal information pertaining to electrical charging or discharging of the electric vehicle, the electric vehicle including a presentation means that presents the proposal information.

An electric power management system in accordance with an example aspect of the present invention includes an electric power management apparatus and a terminal apparatus, the electric power management apparatus including: a management means that manages an amount of electric power stored in a target area; a changing means that causes a parameter associated with a user of an electric vehicle in the target area to undergo a change in accordance with the amount of electric power stored; and a proposal information generation means that generates proposal information for the user in accordance with the amount of electric power stored, the proposal information pertaining to electrical charging or discharging of the electric vehicle, the terminal apparatus including a presentation means that presents the proposal information.

An electric power management method in accordance with an example aspect of the present invention includes: managing an amount of electric power stored in a target area; causing a parameter associated with a user of an electric vehicle in the target area to undergo a change in accordance with the amount of electric power stored; generating proposal information for the user in accordance with the amount of electric power stored, the proposal information pertaining to electrical charging or discharging of the electric vehicle; and presenting the proposal information.

### Advantageous Effects of Invention

According to an example aspect of the present invention, it is possible to better control an amount of electric power stored in a target area in which an electric vehicle is electrically charged and discharged.

### BRIEF DESCRIPTION OF DRAWINGS

FIG. 1 is a block diagram illustrating a configuration of an electric power management apparatus in accordance with a first example embodiment of the present invention.

FIG. 2 is a flowchart illustrating a flow of an electric power management method in accordance with the first example embodiment of the present invention.

FIG. 3 is a block diagram illustrating a configuration of an electric power management system in accordance with a second example embodiment of the present invention.

FIG. 4 is a flowchart illustrating a flow of an electric power management method in accordance with the second example embodiment of the present invention.

FIG. 5 is a block diagram illustrating a configuration of an electric power management system in accordance with a third example embodiment of the present invention.

FIG. 6 is a flowchart illustrating a flow of an electric power management method in accordance with the third example embodiment of the present invention.

FIG. 7 is a block diagram illustrating a configuration of an electric power management system in accordance with a fourth example embodiment of the present invention.

FIG. 8 is a block diagram illustrating a configuration of an electric power management apparatus in accordance with the fourth example embodiment of the present invention.

FIG. 9 is a flowchart illustrating a flow of an electric power management method in accordance with the fourth example embodiment of the present invention.

FIG. 10 is a flowchart illustrating a detailed flow of a proposal information generation process illustrated in FIG. 9.

FIG. 11 is a flowchart illustrating a detailed flow of a changing process illustrated in FIG. 9.

FIG. 12 is a view illustrating a specific example of information displayed in an electric vehicle in a case where an amount of electric power stored is sufficient in the fourth example embodiment of the present invention.

FIG. 13 is a view illustrating a specific example of information displayed in an electric vehicle in a case where the amount of electric power stored is insufficient in the fourth example embodiment of the present invention.

FIG. 14 is a block diagram illustrating a configuration of an electric power management system in accordance with a fifth example embodiment of the present invention.

FIG. 15 is a block diagram illustrating a configuration of an electric power management system in accordance with a variation of the present invention.

FIG. 16 is a diagram illustrating an example of a hardware configuration of an apparatus included in each of the example embodiments of the present invention.

### EXAMPLE EMBODIMENTS

### First Example Embodiment

The following description will discuss in detail a first example embodiment of the present invention, with reference to drawings. The present example embodiment is a basic form of an example embodiment described later.

### <Configuration of Electric Power Management Apparatus 10>

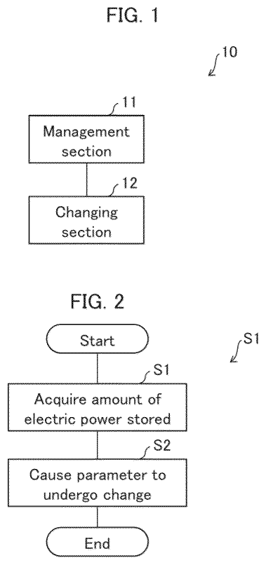

A configuration of an electric power management apparatus 10 in accordance with the present example embodiment is described with reference to FIG. 1. FIG. 1 is a block diagram illustrating a configuration of the electric power management apparatus 10. As illustrated in FIG. 1, the electric power management apparatus 10 includes a management section 11 and a changing section 12. The management section 11 is an example of a configuration that realizes “management means” recited in the claims. The changing section 12 is an example of a configuration that realizes “changing means” recited in the claims.

The management section 11 manages an amount of electric power stored in a target area. The changing section 12 causes a parameter associated with a user of an electric vehicle in the target area to undergo a change in accordance with the amount of electric power stored. These functional blocks will be discussed in detail in “Flow of electric power management method S1” (described later).

### <Flow of Electric Power Management Method S1>

The electric power management apparatus 10 configured as described above carries out an electric power management method S1 in accordance with the present example embodiment. The following description will discuss a flow of the electric power management method S1 with reference to FIG. 2. FIG. 2 is a flowchart illustrating a flow of the electric power management method S1. As illustrated in FIG. 2, the electric power management method S1 includes steps S11 and S12.

In the step S11, the management section 11 manages the amount of electric power stored in the target area.

Note here that the target area means an area in which it is possible to carry out electrical charging and discharging of an electric vehicle. Note here that the “area in which it is possible to carry out electrical charging and discharging of an electric vehicle” may be, for example, an area that includes one or more storage batteries each of which can be electrically charged by and discharged into an electric vehicle. In this case, the management section 11 manages an amount of electric power stored in the one or more storage batteries included in the target area. For example, the management section 11 may periodically acquire an amount of electric power stored in the one or more storage batteries included in the target area.

In the step S12, the changing section 12 causes a parameter associated with a user of an electric vehicle in the target area to undergo a change in accordance with the amount of electric power stored.

Note here that the “electric vehicle in the target area” can be, for example, an “electric vehicle that can be electrically charged and discharged in the target area”. Further, the “electric vehicle that can be electric vehicle that can be electrically charged and discharged in the target area” can be an electric vehicle whose positional information indicates a position included in the target area. In this case, the changing section 12 acquires the positional information of the electric vehicle, and carries out the process of the step S12 in a case where the position indicated by the positional information is included in the target area. Further, as another example, the “electric vehicle that can be electrically charged and discharged in the target area” can be an electric vehicle that is stored in association with the target area. In this case, the changing section 12 refers to a storage apparatus in which correspondences between electric vehicles and areas are stored, and carries out the process of the step S12 in a case where the target area is associated with an electric vehicle. Note, however, that the “electric vehicle in the target area” is not limited to the examples described above. Further, the number of “electric vehicles in the target area” can be one, or more than one.

The “parameter associated with a user” is a parameter that can provide an advantage to the user by undergoing a change. Specific examples of the parameter include a payment given or received by the user, a level given to the user through evaluation, and a rank of the user among a plurality of users. Note, however, that specific examples of the parameter are not limited to the above examples.

### <Program Implementation Example>

Note that in a case where the electric power management apparatus 10 is constituted by a computer, the following program is stored in a memory referred to by the computer. The program is a program for causing the computer to function as the electric power management apparatus 10 and causes the computer to function as (i) the management section 11 which manages an amount of electric power stored in the target area and (ii) the changing section 12 which causes a parameter associated with a user of an electric vehicle in the target area to undergo a change in accordance with the amount of electric power stored.

### <Example Advantage of the Present Example Embodiment>

As described above, the present example embodiment employs a configuration in which (i) an amount of electric power stored in a target area is managed and (ii) a parameter associated with a user of an electric vehicle in the target area is caused to undergo a change in accordance with the amount of electric power stored.

As such, according to the present example embodiment, it is expected that the user carries out electrical charging or discharging of the electric vehicle in the target area on the basis of the parameter which is caused to undergo a change in accordance with the amount of electric power stored. This brings about an advantage that it is possible to better control the amount of electric power stored in the target area in which an electric vehicle is electrically charged and discharged.

### Second Example Embodiment

The following description will discuss in detail a second example embodiment of the present invention, with reference to drawings. Note that components having the same functions as those described in the first example embodiment are denoted by the same reference numerals, and a description thereof will be omitted accordingly.

### <Configuration of Electric Power Management System 1A>

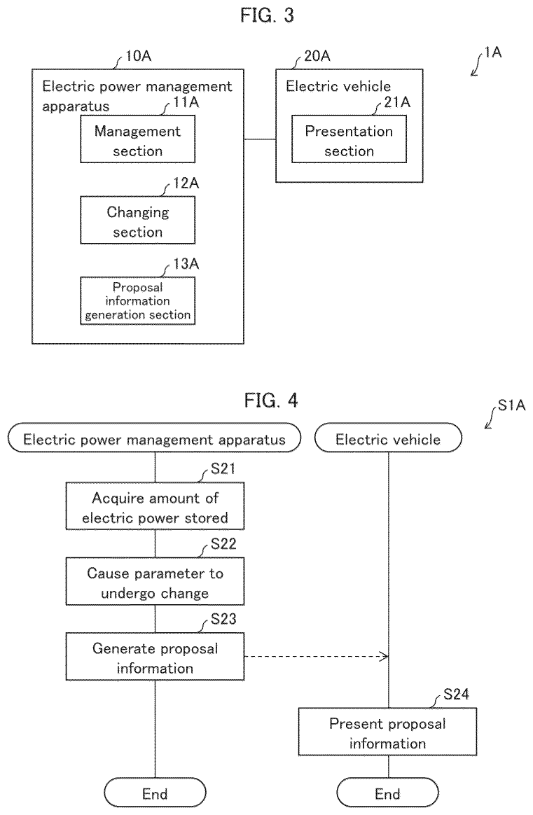

A configuration of an electric power management system 1A in accordance with the present example embodiment is described with reference to FIG. 3. FIG. 3 is a block diagram illustrating a configuration of the electric power management system 1A. As illustrated in FIG. 3, the electric power management system 1A includes an electric power management apparatus 10A and an electric vehicle 20A. The electric power management apparatus 10A and the electric vehicle 20A are communicatively connected to each other.

The electric power management apparatus 10A includes a management section 11A, a changing section 12A, and a proposal information generation section 13A. The management section 11A and the changing section 12A are configured to be similar to the management section 11 and the changing section 12 in the first example embodiment. The proposal information generation section 13A generates proposal information for a user in accordance with an amount of electric power stored, the proposal information pertaining to electrical charging or discharging of the electric vehicle 20A. The electric vehicle 20A includes a presentation section which 21A presents proposal information. The proposal information generation section 13A is an example of a configuration that realizes “proposal information generation means” recited in the claims. The presentation section 21A is an example of a configuration that realizes “presentation means” recited in the claims. The proposal information generation section 13A and the presentation section 21A will be discussed in detail in “Flow of electric power management method S1A” (described later).

### <Flow of Electric Power Management Method S1A>

The following description will discuss a flow of an electric power management method S1A in accordance with the present example embodiment, with reference to FIG. 4. FIG. 4 is a flowchart illustrating a flow of the electric power management method S1A. As illustrated in FIG. 4, the electric power management method S1A includes steps S21 to S24. The steps S21 and S22 are similar to the steps S11 and S12 in accordance with the first example embodiment, and detailed descriptions thereof will not be repeated.

In the step S23, the proposal information generation section 13A generates proposal information for a user in accordance with an amount of electric power stored, the proposal information pertaining to electrical charging or discharging of the electric vehicle 20A. For example, the proposal information generation section 13A can generate proposal information that proposes an advantage that is brought as a result of a change in parameter in accordance with the amount of electric power stored. Further, for example, the proposal information generation section 13A can generate, in a case of determining that the amount of electric power stored is sufficient, proposal information that proposes electrical charging. Further, for example, the proposal information generation section 13A can generate, in a case of determining that the amount of electric power stored is insufficient, proposal information that proposes electrical discharging. Further, the proposal information generation section 13A transmits the proposal information thus generated to the electric vehicle 20A.

In the step S24, the presentation section 21A of the electric vehicle 20A presents the proposal information. For example, the presentation section 21A can display the proposal information on a display apparatus provided in the electric vehicle 20A. Further, for example, the presentation section 21A can output the proposal information, in audio form, to an audio output apparatus provided in the electric vehicle 20A.

### <Example Advantage of the Present Example Embodiment>

As described above, the present example embodiment employs a configuration in which (i) the electric power management apparatus 10A manages an amount of electric power stored in a target area, causes a parameter associated with a user of an electric vehicle in the target area to undergo a change in accordance with the amount of electric power stored, and generates proposal information for the user in accordance with the amount of electric power stored, the proposal information pertaining to electrical charging or discharging of the electric vehicle, and (ii) the electric vehicle 20A presents the proposal information.

As such, according to the present example embodiment, it is expected that the user carries out, in accordance with the proposal information presented at the electric vehicle, electrical charging or discharging of the electric vehicle in the target area on the basis of the parameter which is caused to undergo a change in accordance with the amount of electric power stored. This brings about an advantage that it is possible to better control the amount of electric power stored in the target area in which an electric vehicle is electrically charged and discharged.

### Third Example Embodiment

The following description will discuss in detail a third example embodiment of the present invention, with reference to drawings. Note that components having the same functions as those described in the first and second example embodiments are denoted by the same reference numerals, and a description thereof will be omitted accordingly.

### <Configuration of Electric Power Management System 1B>

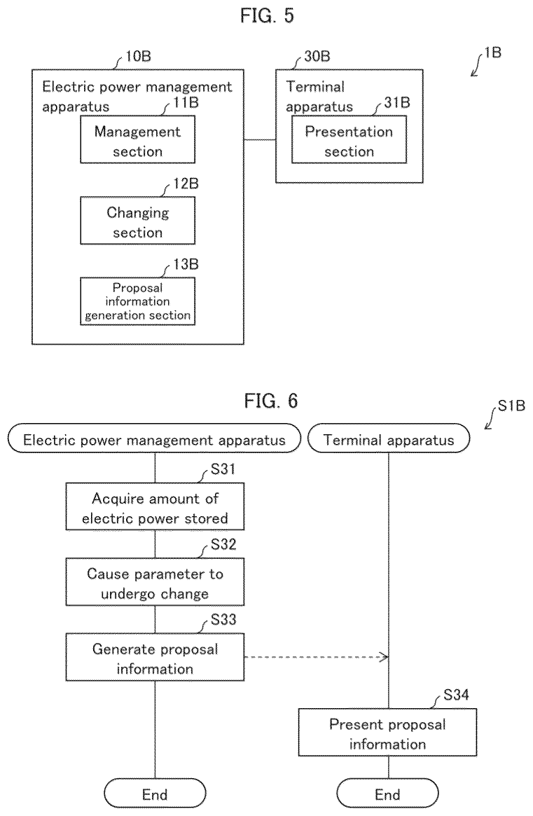

A configuration of an electric power management system 1B in accordance with the present example embodiment is described with reference to FIG. 5. FIG. 5 is a block diagram illustrating a configuration of the electric power management system 1B. As illustrated in FIG. 5, the electric power management system 1B includes an electric power management apparatus 10B and a terminal apparatus 30B. The electric power management apparatus 10B and the terminal apparatus 30B are communicatively connected to each other.

The electric power management apparatus 10B includes a management section 11B, a changing section 12B, and a proposal information generation section 13B. The management section 11B, the changing section 12B, and the proposal information generation section 13B are configured to be similar to the respective functional blocks having the same names in the first example embodiment. The terminal apparatus 30B includes a presentation section 31B which presents proposal information. The presentation section 31B is an example of a configuration that realizes “presentation means” recited in the claims. For example, the terminal apparatus 30B can be a computer that is used by a user of an electric vehicle.

### <Flow of Electric Power Management Method S1B>

The following description will discuss a flow of an electric power management method S1B in accordance with the present example embodiment, with reference to FIG. 6. FIG. 6 is a flowchart illustrating a flow of the electric power management method S1B. As illustrated in FIG. 6, the electric power management method S1B includes steps S31 to S34. The steps S31 to S33 are substantially similar to the steps S21 to S23 in accordance with the second example embodiment, and detailed descriptions thereof will not be repeated. Note, that the however, present example embodiment differs from the second example embodiment in that the terminal apparatus 30B is the destination to which proposal information is transmitted in the step S33.

In the step S34, the presentation section 31B of the terminal apparatus 30B presents the proposal information. For example, the presentation section 31B can display the proposal information on a display apparatus built into or connected to the terminal apparatus 30B. Further, for example, the presentation section 31B can output the proposal information, in audio form, to an audio output apparatus built in or connected to the terminal apparatus 30B.

### <Example Advantage of the Present Example Embodiment>

As described above, the present example embodiment employs a configuration in which (i) the electric power management apparatus 10B manages an amount of electric power stored in a target area, causes a parameter associated with a user of an electric vehicle in the target area to undergo a change in accordance with the amount of electric power stored, and generates proposal information for the user in accordance with the amount of electric power stored, the proposal information pertaining to electrical charging or discharging of the electric vehicle, and (ii) the terminal apparatus 30B presents the proposal information.

As such, according to the present example embodiment, it is expected that the user carries out, in accordance with the proposal information presented at the terminal apparatus, electrical charging or discharging of the electric vehicle in the target area on the basis of the parameter which is caused to undergo a change in accordance with the amount of electric power stored. This brings about an advantage that it is possible to better control the amount of electric power stored in the target area in which an electric vehicle is electrically charged and discharged.

### Fourth Example Embodiment

The following description will discuss in detail a fourth example embodiment of the present invention, with reference to drawings. Note that components having the same functions as those described in the first to third example embodiments are denoted by the same reference numerals, and a description thereof will be omitted accordingly.

### <Configuration of Electric Power Management System 1C>

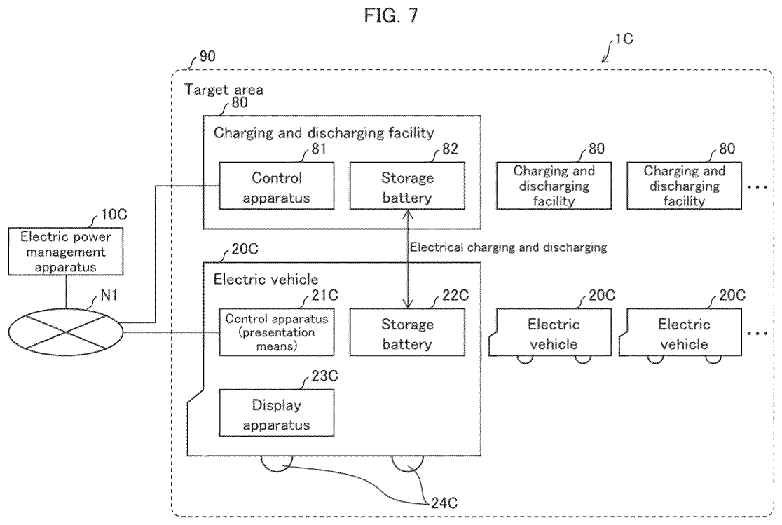

A configuration of an electric power management system 1C in accordance with the present example embodiment is described with reference to FIG. 7. FIG. 7 is a block diagram illustrating a configuration of the electric power management system 1C. As illustrated in FIG. 7, the electric power management system 1C includes an electric power management apparatus 10C, an electric vehicle 20C, and a charging and discharging facility 80. Note that, although FIG. 7 illustrates three electric vehicles 20C and three charging and discharging facilities 80, the number of electric vehicles 20C and the number of charging and discharging facilities 80 provided in the present example embodiment are not limited to these numbers, and the present example embodiment is not limited to a configuration in which the number of electric vehicles 20C is identical to the number of charging and discharging facilities 80. Further, each charging and discharging facility 80 is capable of electrical charging and discharging of any electric vehicle 20C.

The electric power management apparatus 10C is communicatively connected, via a network N1, to a control apparatus 21C included in the electric vehicle 20C. The control apparatus 21C is an example of a configuration that realizes “presentation means” recited in the claims. The electric power management apparatus 10C is also communicatively connected, via the network N1, to a control apparatus 81 included in the charging and discharging facility 80. The network N1 is, for example, constituted by a wireless local area network (LAN), a wired LAN, a wide area network (WAN), a mobile data communication network, or a combination of some or all of these networks. Note, however, that a configuration of the network N1 is not limited to the above examples.

Note that, although FIG. 3 illustrates a single target area 90, the electric vehicles 20C and the charging and discharging facilities 80 included in the electric power management system 1C can be present in a plurality of target areas 90 in a dispersed manner. Further, although FIG. 3 illustrates a single electric vehicle 20C and a single charging and discharging facility 80, a plurality of electric vehicle 20C and a plurality of charging and discharging facilities 80 can be included in a single target area 90. Further, it is sufficient that the electric power management system 1C includes at least the electric power management apparatus 10C, and it is possible to employ a configuration in which part or all of the electric vehicles 20C and the charging and discharging facilities 80 are provided outside the electric power management system 1C.

### (Target Area 90)

As illustrated in FIG. 7, the target area 90 is an area which includes a charging and discharging facility 80 capable of electrical charging and discharging of an electric vehicle 20C. Specific examples of the target area 90 include a commercial facility, a recreational facility, an educational facility, and a medical facility each of which includes the charging and discharging facility 80. Other specific examples of the target area 90 include a district which includes the charging and discharging facility 80. The district can be an administrative district. Note, however, that specific examples of the target area 90 are not limited to the above examples.

### (Configuration of Electric Vehicle 20C)

As illustrated in FIG. 7, the electric vehicle 20C includes the control apparatus 21C, a storage battery 22C, a display apparatus 23C, and a conveyance mechanism 24C. The electric vehicle 20C moves by controlling the conveyance mechanism 24C by being supplied with electric power from the storage battery 22C. The electric vehicle 20C carries out electrical charging or discharging of the storage battery 22C in the target area 90.

“Carrying out electrical charging or discharging in the target area 90” can mean, for example, that a charging and discharging facility 80 that is detected carrying out electrical charging or discharging of the electric vehicle 20C is included in the target area 90. Further, for example, “carrying out electrical charging or discharging in the target area 90” can mean that current positional information of the electric vehicle 20C indicates a position included in the target area 90. In this case, the current positional information of the electric vehicle 20C can be information detected with use of a positioning sensor included in the electric vehicle 20C or a positioning sensor included in a terminal carried by a user of the electric vehicle 20C. Further, for example, “carrying out electrical charging or discharging in the target area 90” can mean that predicted positional information of the electric vehicle 20C indicates a position included in the target area 90. In this case, the predicted positional information of the electric vehicle 20C can be information that is predicted on the basis of a movement path of the electric vehicle 20C. Further, for example, “carrying out electrical charging or discharging in the target area 90” can mean that a target area 90 is registered in association with the electric vehicle 20C.

### (Configuration of Charging and Discharging Facility 80)

As illustrated in FIG. 7, the charging and discharging facility 80 is a facility which includes the control apparatus 81 and a storage battery 82 and carries out electrical charging and discharging of the electric vehicle 20C. Electrical charging of the electric vehicle 20C by the charging and discharging facility 80 is carried out such that electric power supplied from the storage battery 82 is inputted to the storage battery 22C. Electrical discharging of the electric vehicle 20C by the charging and discharging facility 80 is carried out such that electric power supplied from the storage battery 22C is inputted to the storage battery 82.

### (Configuration of Electric Power Management Apparatus 10C)

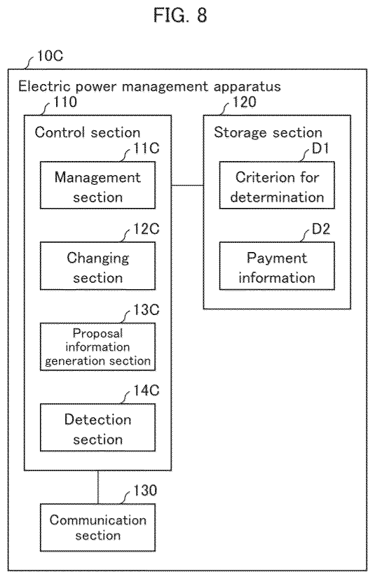

The electric power management apparatus 10C is an apparatus that manages an amount of electric power stored in the target area 90. The following description will discuss a configuration of the electric power management apparatus 10C, with reference to FIG. 8. FIG. 8 is a block diagram illustrating a configuration of the electric power management apparatus 10C. As illustrated in FIG. 8, the electric power management apparatus 10C includes a control section 110, a storage section 120, and a communication section 130. The control section 110 collectively controls sections of the electric power management apparatus 10C. The storage section 120 stores therein various data used by the control section 110. The communication section 130 transmits and receives data to and from another apparatus, under the control of the control section 110.

The control section 110 includes a management section 11C, a changing section 12C, a proposal information generation section 13C, and a detection section 14C. The management section 11C manages an amount of electric power stored in the target area 90.

The changing section 12C causes a parameter associated with a user of an electric vehicle 20C, electrical charging or discharging of which has been detected in the target area 90, to undergo a change in accordance with the amount of electric power stored. Specifically, the changing section 12C makes a determination as to whether or not the amount of electric power stored is sufficient, and in a case of determining that the amount of electric power stored is sufficient, causes the parameter to undergo a change in accordance with electrical charging of the electric vehicle 20C. Further, the changing section 12C makes a determination as to whether or not the amount of electric power stored is sufficient, and in a case of determining that the amount of electric power stored is insufficient, causes the parameter to undergo a change in accordance with electrical discharging of the electric vehicle 20C. Further, the parameter caused by the changing section 12C to undergo a change is a payment given or received by the user of the electric vehicle 20C in the target area 90. Hereinafter, the parameter caused by the changing section 12C to undergo a change will be referred to as “payment given or received”.

The proposal information generation section 13C generates proposal information for a user of an electric vehicle 20C in the target area 90 in accordance with the amount of electric power stored, the proposal information pertaining to electrical charging or discharging of the electric vehicle 20C. The detection section 14C detects electrical charging or discharging of an electric vehicle 20C in the target area 90.

The detection section 14C is an example of a configuration for realizing a detection means recited in the claims. These sections will be discussed in detail in “Flow of electric power management method S1C” (described later).

The various data stored in the storage section 120 include a criterion D1 for determination and payment information D2. The criterion D1 for determination is information which is referred to when a determination is made as to whether or not the amount of electric power stored is sufficient or whether or not a threshold is unmet. The payment information D2 is information pertaining to a payment given or received by a user. The payment information D2 is referred to when a payment given or received by a user is caused to undergo a change. These pieces of information will be discussed in detail in “Flow of electric power management method S1C” (described later).

### <Flow of Electric Power Management Method S1C>

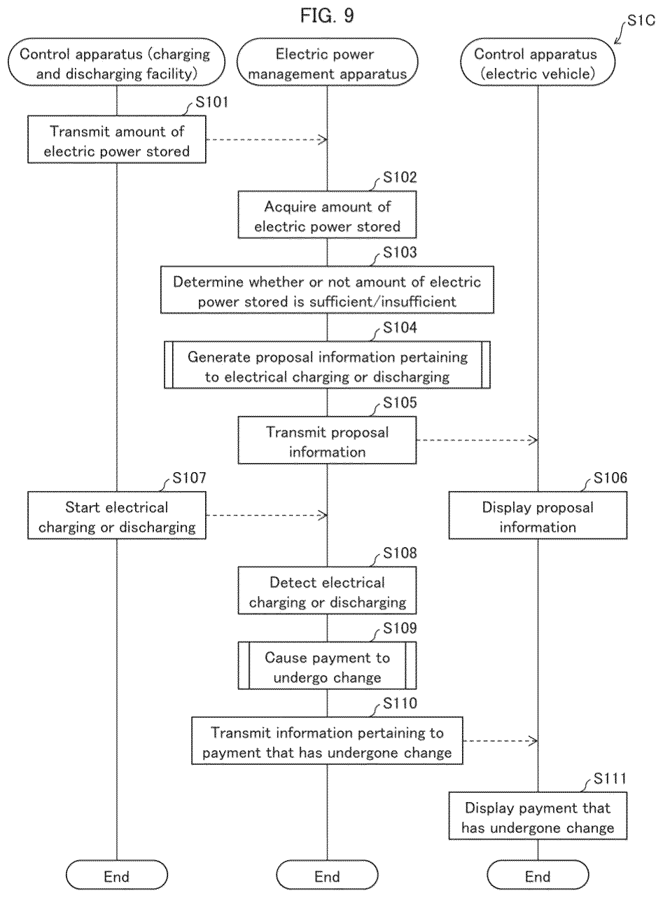

The electric power management system 1C configured as described above carries out an electric power management method SIC in accordance with the present example embodiment. The following description will discuss a flow of the electric power management method SIC with reference to FIG. 9. FIG. 9 is a flowchart illustrating a flow of the electric power management method SIC. As illustrated in FIG. 9, the electric power management method SIC includes steps S101 to S111.

### (Step S101)

In the step S101, the control apparatus 81 of the charging and discharging facility 80 detects an amount of electric power stored in the storage battery 82 and transmits the detected amount of electric power stored to the electric power management apparatus 10C.

### (Step S102)

In the step S102, the management section 11C of the electric power management apparatus 10C acquires the amount of electric power stored. For example, the management section 11C may periodically acquire an amount of electric power stored in one or more charging and discharging facilities 80 included in the target area 90 and store, in the storage section 120, a sum of the acquired amounts of electric power stored. In this case, the management section 11C acquires, in the step S102, an amount of electric power stored that was most recently stored in the storage section 120.

### (Step S103)

In the step S103, the changing section 12C makes a determination as to whether or not the amount of electric power stored is sufficient or whether or not the amount of electric power stored is insufficient. Specifically, the changing section 12C makes the determination with reference to the criterion D1 for determination.

### (Specific Example of Criterion D1 for Determination)

For example, the criterion D1 for determination includes information indicative of a condition for the amount of electric power stored to be sufficient and information indicative of a condition for the amount of electric power stored to be insufficient. The condition for the amount of electric power stored to be sufficient includes, for example, a condition that the amount of electric power stored is not less than a threshold. The condition for the amount of electric power stored to be insufficient includes, for example, a condition that the amount of electric power stored is less than a threshold. The threshold included in the condition for the amount of electric power stored to be sufficient does not necessarily have to be identical to the threshold included in the condition for the amount of electric power stored to be insufficient, but the following description will be given on the assumption that these thresholds are identical to each other. In this case, the changing section 12C determines, in a case where the amount of electric power stored is not less than the threshold, that the amount of electric power stored is sufficient, and determines, in a case where the amount of electric power stored is less than the threshold, that the amount of electric power stored is insufficient.

### (Step S104)

In the step S104, the proposal information generation section 13C refers to a result of the determination made in the step S103, and generates proposal information for a user of an electric vehicle 20C in the target area 90 in accordance with the amount of electric power stored, the proposal information pertaining to electrical charging or discharging of the electric vehicle 20C.

### (Details of Step S104)

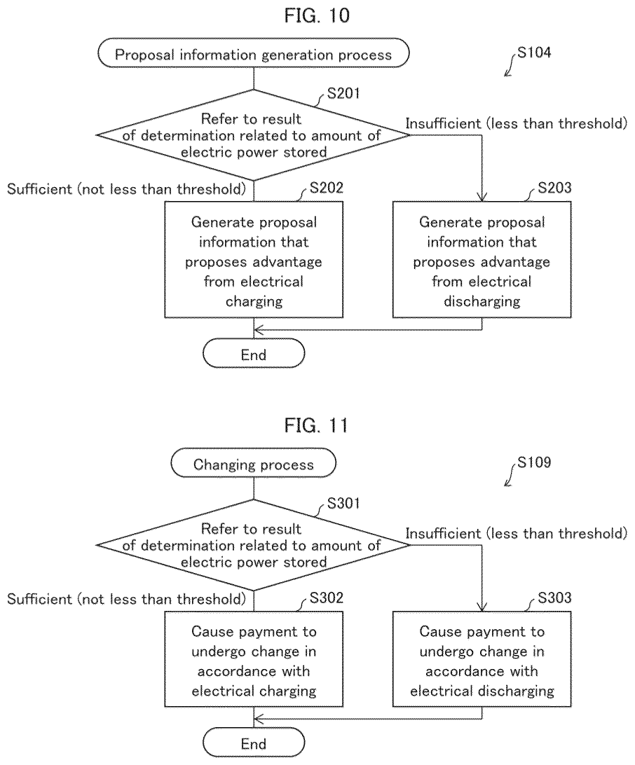

The details of the step S104 are described with reference to FIG. 10. FIG. 10 is a flowchart illustrating a detailed flow of a proposal information generation process in the step S104.

As illustrated in FIG. 10, the proposal information generation process (step S104) includes steps S201 to S203.

### (Step S201)

In the step S201, the proposal information generation section 13C refers to the result of the determination made in the step S103 and causes branching of the process. In a case where the amount of electric power stored is sufficient, the subsequent step S202 is carried out. In a case where the amount of electric power stored is insufficient, the step S203 (described later) is carried out.

### (Step S202)

In the step S202, the proposal information generation section 13C generates proposal information that proposes an advantage derived from carrying out electric charging of the electric vehicle 20C.

### (Step S203)

In the step S202, the proposal information generation section 13C generates proposal information that proposes an advantage derived from carrying out electric discharging of the electric vehicle 20C.

Thus, the proposal information generation process is ended, and the step S105 illustrated in FIG. 9 is subsequently carried out.

### (Step S105)

In the step S105, the proposal information generation section 13C transmits the proposal information which has been generated to the electric vehicle 20C.

### (Step S106)

In the step S106, the control apparatus 21C of the electric vehicle 20C displays, on the display apparatus 23C, the proposal information which has been received. This allows the proposal information to be viewed by the user of the electric vehicle 20C.

### (User of Electric Vehicle 20C)

Note here that a user of an electric vehicle 20C can be a user who is registered in association with the electric vehicle 20C. In this case, for example, a database that stores therein information in which an ID of an electric vehicle 20C and a user ID are associated with each other can be referred to. Further, a user of an electric vehicle 20C can be a user who is involved in electrical charging and discharging of the electric vehicle 20C. The user who is involved in electrical charging and discharging can be a user who instructs that electrical charging or discharging should be carried out, or can be a user who gives or receives a payment related to electrical charging or discharging. Specifically, for example, a user who pays a usage fee by carrying out electrical charging of the electric vehicle 20C at the charging and discharging facility 80 or a user who receives a reward by carrying out electrical discharging of the electric vehicle 20C at the charging and discharging facility 80 can be regarded as a user of the electric vehicle 20C.

### (Step S107)

In the step S107, the control apparatus 81 of the charging and discharging facility 80 starts electrical charging or discharging of the electric vehicle 20C and transmits, to the electric power management apparatus 10C, start information which indicates that the electric power management apparatus 10C has started the electrical charging or discharging. This step is carried out, for example, in a case where (i) the storage battery 82 and the storage battery 22C are connected to each other and (ii) an operation by the user of the electric vehicle 20C to start electrical charging or discharging is received.

### (Step S108)

In the step S108, the detection section 14C of the electric power management apparatus 10C detects electrical charging or discharging of the electric vehicle 20C in the target area 90, by receiving start information from the control apparatus 81.

### (Step S109)

In the step S109, the changing section 12C refers to the result of the determination made in the step S103 and causes a payment given or received by the user of the electric vehicle 20C, the electrical charging or discharging of which has been detected in the target area 90, to undergo a change in accordance with the amount of electric power stored. Specifically, for example, the changing section 12C can refer to the payment information D2 and cause the payment given or received by the user to undergo a change from a usual value.

### (Specific Examples of Payment Given or Received by User)

Note here that the payment given or received by the user encompasses a payment paid by the user or a payment received by the user. Specific examples of the payment paid by the user include a fee paid by the user in accordance with electrical charging carried out at the charging and discharging facility 80, a parking fee at a parking lot included in the target area 90, a toll for using a road included in the target area 90, and a usage fee for using various services provided in the target area 90. Specific examples of the payment received by the user include a fee paid to the user in accordance with electrical discharging carried out at the charging and discharging facility 80, and a local currency, a coupon, or the like that can be used to utilize a service provided in the target area 90. Note, however, that the payment given or received by the user is not limited to these.

### (Specific Example of Payment Information D2)

The payment information D2 includes information pertaining to a payment that is given or received by the user and that is to be caused to undergo a change. For example, the payment information D2 includes information pertaining to a usual value regarding a payment that is to be caused to undergo a change. The usual value can be a value that is determined in accordance with an element other than the amount of electric power stored.

### (Details of Step S109)

The details of the step S109 are described with reference to FIG. 11. FIG. 11 is a flowchart illustrating a detailed flow of a changing process in the step S109.

As illustrated in FIG. 11, the changing process (step S109) includes steps S301 to S303.

### (Step S301)

In the step S301, the changing section 12C refers to the result of the determination made in the step S103 and causes branching of the process. In a case where the amount of electric power stored is sufficient, the subsequent step S302 is carried out. In a case where the amount of electric power stored is insufficient, the step S303 (described later) is carried out.

### (Step S302)

In the step S302, the changing section 12C causes the payment given or received by the user to undergo a change in accordance with electric charging. Specifically, for example, the changing section 12C refers to the payment information D2 and carries out a changing process in accordance with electrical charging.

(Specific Examples of Changing Process in Accordance with Electrical Charging)

The changing section 12C causes the payment given or received by the user to undergo a change in accordance with electrical charging so as to increase an advantage brought about to the user by the payment. For example, the changing section 12C can (i) cause the payment paid by the user to undergo a change in accordance with electrical charging such that the payment becomes less than usual or (ii) cause the payment received by the user to undergo a change in accordance with electrical charging such that the payment becomes more than usual. For example, as an example of the above-described (i), the changing section 12C can discount a fee to be paid by the user in accordance with electrical charging itself.

Other specific examples of the (i) include a process of giving, to the user, a discount coupon of a parking fee, a toll, or the like in the target area 90. Specific examples of the (ii) include a process of giving a local currency to the user.

### (Step S303)

In the step S303, the changing section 12C causes the payment given or received by the user to undergo a change in accordance with electric discharging. Specifically, for example, the changing section 12C refers to the payment information D2 and carries out a changing process in accordance with electrical discharging.

### (Specific Examples of Payment Changing Process in Accordance With Electrical Discharging)

The changing section 12C causes the payment given or received by the user to undergo a change in accordance with electrical discharging so as to increase an advantage brought about to the user by the payment. For example, the changing section 12C can (i) cause the payment paid by the user to undergo a change in accordance with electrical discharging such that the payment becomes less than usual or (ii) cause the payment received by the user to undergo a change in accordance with electrical discharging such that the payment becomes more than usual. For example, as an example of the above-described (ii), the changing section 12C can cause a fee itself, which is to be paid to the user in accordance with electrical discharging, to be more than usual. Other specific examples of the (i) and the (ii) can be ones similar to the specific examples described in the step S302.

Thus, the changing process is ended, and the step S110 illustrated in FIG. 9 is subsequently carried out.

### (Step S110)

In the step S110, the changing section 12C transmits, to the electric vehicle 20C, information pertaining to the payment which has undergone a change.

### (Step S111)

In the step S111, the control apparatus 21C of the electric vehicle 20C displays, on the display apparatus 23C, the information pertaining to the payment which has undergone a change. This allows the user to recognize the information pertaining to the payment which has undergone a change by electrical charging or discharging.

(Example screen of Electric Vehicle 20C in a Case Where Amount of Electric Power Stored is Sufficient)

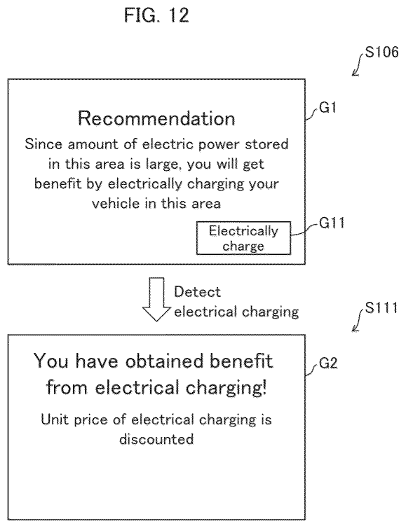

The following description will discuss, with reference to FIG. 12, a specific example of a screen that is displayed on the display apparatus 23C of the electric vehicle 20C in the steps S106 and S111 in a case where it is determined in the step S103 that the amount of electric power stored is sufficient. Hereinafter, being displayed on the display apparatus 23C of the electric vehicle 20C may also be referred to simply as being displayed on the electric vehicle 20C. FIG. 12 is a view illustrating a specific example of information displayed in the electric vehicle 20C in a case where the amount of electric power stored is sufficient.

As illustrated in FIG. 12, in the step S106, an example screen G1 is displayed in the electric vehicle 20C because the amount of electric power stored in the target area 90 is sufficient. The example screen G1 includes text information that reads “Since the amount of electric power stored in this area is large, you will get a benefit by electrically charging your vehicle in this area”, which is an example of the proposal information that proposes an advantage derived from carrying out electrical charging. Further, the example screen G1 includes an operation object G11 for receiving an operation indicating “Electrically charge”. In this example, in a case where the user carries out an operation with respect to the operation object G11, a request that electrical charging should be started is transmitted from the control apparatus 21C of the electric vehicle 20C to the control apparatus 81 of the charging and discharging facility 80. This causes electric charging from the storage battery 22C to the storage battery 82 to start.

Further, as illustrated in FIG. 12, in the step S111, an example screen G2 is displayed in the electric vehicle 20C because electrical charging of the electric vehicle 20C in the target area 90 has been detected. The example screen G2 includes text information that reads “You have obtained benefit from electrical charging! Unit price of electrical charging is discounted”, which is a result of the change undergone. Thus, the example screen G2 allows the user to recognize a result of a change which the payment to be paid by the user has undergone, in accordance with the electrical charging, to become less than usual.

### (Example Screen of Electric Vehicle 20C in a Case Where Amount of Electric Power Stored is Insufficient)

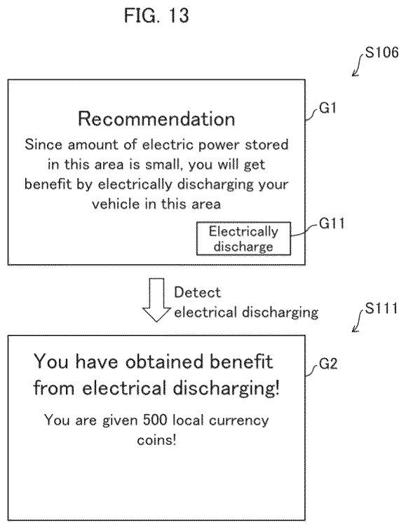

The following description will discuss, with reference to FIG. 13, a specific example of a screen that is displayed in the electric vehicle 20C in the steps S106 and S111 in a case where it is determined in the step S103 that the amount of electric power stored is insufficient. FIG. 13 is a view illustrating a specific example of information displayed in the electric vehicle 20C in a case where the amount of electric power stored is insufficient.

As illustrated in FIG. 13, in the step S106, an example screen G3 is displayed in the electric vehicle 20C because the amount of electric power stored in the target area 90 is insufficient. The example screen G3 includes text information that reads “Since the amount of electric power stored in this area is small, you will get a benefit by electrically discharging your vehicle in this area”, which is an example of the proposal information that proposes an advantage derived from carrying out electrical discharging. Further, the example screen G3 includes an operation object G31 for receiving an operation indicating “Electrically discharge”. In this example, in a case where the user carries out an operation with respect to the operation object G31, a request that electrical discharging should be started is transmitted from the control apparatus 21C of the electric vehicle 20C to the control apparatus 81 of the charging and discharging facility 80, and electrical discharging from the storage battery 22C to the storage battery 82 is started.

Further, as illustrated in FIG. 13, in the step S111, an example screen G4 is displayed in the electric vehicle 20C because electrical discharging of the electric vehicle 20C in the target area 90 has been detected. The example screen G4 includes text information that reads “You have obtained benefit from electrical discharging! You are given 500 local currency coins”, which is a result of the change undergone. Thus, the example screen G4 allows the user to recognize a result of a change which the payment to be received by the user has undergone, in accordance with the electrical discharging, to become more than usual.

### <Application Example>

For example, the present example embodiment is applicable in the following manner while an electric vehicle 20C is travelling in the target area 90. When proposal information that proposes an advantage related to electrical discharging is displayed in the electric vehicle 20C, a user who is riding in the electric vehicle 20C stops by at a charging and discharging facility 80 in the target area 90 and carries out electrical discharging of the electric vehicle 20C. Further, the user uses a given service in the target area 90 with use of a local currency which the user receives as a benefit from carrying out electrical discharging. This enables good control of the amount of electric power stored in the target area 90.

Further, when proposal information that proposes an advantage related to electrical charging is displayed in the electric vehicle 20C, the user who is riding in the electric vehicle 20C stops by at a charging and discharging facility 80 in the target area 90 and carries out electrical discharging of the electric vehicle 20C. Further, the user makes a payment at a unit price of electrical charging discounted as a benefit from carrying out the electrical charging. This enables good control of the amount of electric power stored in the target area 90.

Further, in a case where the electric vehicle 20C travels in a plurality of target areas 90, the user is able to expect to carry out electrical charging or discharging in a target area 90 that provides a greater advantage (a target area 90 that provides a larger payment to be received or a smaller payment to be paid). This enables good control of the amount of electric power stored in each target area 90.

### <Example Advantage of the Present Example Embodiment>

As described above, in the present example embodiment, a payment given or received by a user is employed as the parameter that is associated with a user and caused to undergo a change in accordance with the amount of electric power stored.

As such, with use of the present example embodiment, it can be expected that electrical charging or discharging that yields a larger payment received by the user or electrical charging or discharging that yields a smaller payment paid to the user is carried out. As a result, electrical charging or discharging of the electric vehicle 20C is carried out more properly in accordance with the amount of electric power stored. This makes it possible to better control the amount of electric power stored.

Further, the present example embodiment employs a configuration in which (i) electrical charging or discharging of an electric vehicle 20C in the target area 90 is detected and (ii) a payment given or received by a user of the electric vehicle 20C, the electrical charging or discharging of which has been detected, is caused to undergo a change in accordance with the amount of electric power stored.

This allows a user of the electric vehicle 20C which has been electrically charged or discharged to enjoy an advantage derived from the change undergone by the payment given or received by the user.

Further, the present example embodiment employs a configuration in which proposal information for a user of an electric vehicle 20C in the target area 90 is generated in accordance with the amount of electric power stored, the proposal information pertaining to electrical charging or discharging of the electric vehicle 20C.

As such, it can be expected that electrical charging or discharging is carried out in accordance with the proposal information. As a result, electrical charging or discharging of the electric vehicle 20C is carried out more properly in accordance with the amount of electric power stored. This makes it possible to better control the amount of electric power stored.

Further, the present example embodiment employs a configuration in which a determination is made as to whether or not the amount of electric power stored is sufficient, and in a case where it is determined that the amount of electric power stored is sufficient, a payment given or received by the user is caused to undergo a change in accordance with electrical charging of the electric vehicle 20C.

As such, in a case where the amount of electric power stored is sufficient, the payment can be caused to undergo a change in accordance with electrical charging so as to enable the user to enjoy an advantage. As a result, electrical charging of the electric vehicle 20C is carried out more properly. This makes it possible to better control the amount of electric power stored.

Further, the present example embodiment employs a configuration in which a determination is made as to whether or not the amount of electric power stored is insufficient, and in a case where it is determined that the amount of electric power stored is insufficient, a payment given or received by the user is caused to undergo a change in accordance with electrical discharging of the electric vehicle 20C.

As such, in a case where the amount of electric power stored is insufficient, the payment can be caused to undergo a change in accordance with electrical discharging so as to enable the user to enjoy an advantage. As a result, electrical charging of the electric vehicle 20C is carried out more properly. This makes it possible to better control the amount of electric power stored.

### Fifth Example Embodiment

The following description will discuss in detail a fifth example embodiment of the present invention, with reference drawings. Note that components having the same to functions as those described in the first to fourth example embodiments are denoted by the same reference numerals, and a description thereof will be omitted accordingly.

### <Configuration of Electric Power Management System 1D>

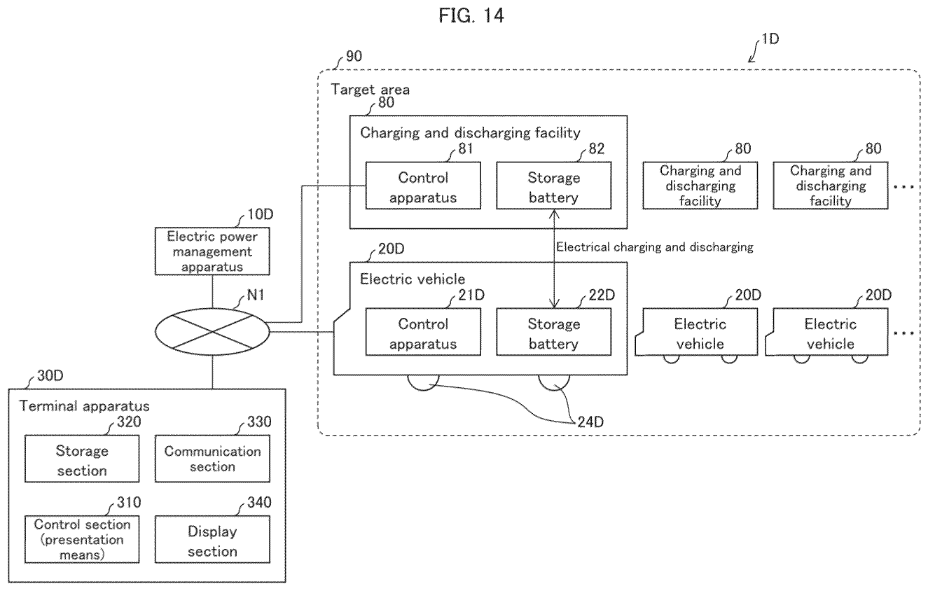

The present example embodiment is an example aspect obtained by modifying the above-described fourth example embodiment such that the proposal information is displayed in a terminal apparatus 30D, not in the electric vehicle 20C. An electric power management system 1D in accordance with the present example embodiment is described with reference to FIG. 14. FIG. 14 is a block diagram illustrating a configuration of the electric power management system 1D in accordance with the present example embodiment.

As illustrated in FIG. 14, the electric power management system 1D includes an electric power management apparatus 10D, an electric vehicle 20D, the terminal apparatus 30D, and a charging and discharging facility 80. The electric vehicle 20D is configured to be substantially similar to the electric vehicle 20C in accordance with the fourth example embodiment, except that the electric vehicle 20D does not necessarily have to include the display apparatus 23C. Specifically, the electric vehicle 20D includes a control apparatus 21D, a storage battery 22D, and a conveyance mechanism 24D. The control apparatus 21D, the storage battery 22D, and the conveyance mechanism 24D are configured to be similar to the respective sections having the same names in the fourth example embodiment. Note that, although FIG. 14 illustrates three electric vehicles 20D and three charging and discharging facilities 80, the number of electric vehicles 20D and the number of charging and discharging facilities 80 provided in the present example embodiment are not limited to these numbers, and the present example embodiment is not limited to a configuration in which the number of electric vehicles 20D is identical to the number of charging and discharging facilities 80. Further, each charging and discharging facility 80 is capable of electrical charging and discharging of any electric vehicle 20D. Further, it is sufficient that the electric power management system 1D includes at least the electric power management apparatus 10D, and it is possible to employ a configuration in which all or part of the electric vehicles 20D, the terminal apparatus 30D, and the charging and discharging facilities 80 are provided outside the electric power management system 1D.

### (Configuration of Electric Power Management Apparatus 10D)

As illustrated in FIG. 14, the electric power management apparatus 10D is communicatively connected, via a network N1, to the electric vehicle 20D and the charging and discharging facility 80 and also to the terminal apparatus 30D. Further, the electric power management apparatus 10D is configured to be substantially similar to the electric power management apparatus 10C illustrated in FIG. 8, except that details of the proposal information generation section 13C are slightly different. The proposal information generation section 13C transmits generated proposal information to the terminal apparatus 30D, not to the electric vehicle 20D.

### <Configuration of Terminal Apparatus 30D>

The terminal apparatus 30D is a computer used by a user of the electric vehicle 20D. Examples of the terminal apparatus 30D include, but are not limited to, a smart phone, a tablet, a personal computer, a wearable computer, and the like. As illustrated in FIG. 14, the terminal apparatus 30D includes a storage section 320, a control section 310, a communication section 330, and a display section 340. The control section 310 is an example of a configuration that realizes “presentation means” recited in the claims. The control section 310 collectively controls sections of the terminal apparatus 30D. The control section 310 displays, on the display section 340, the proposal information which has been received from the electric power management apparatus 10D. The storage section 320 stores therein various data used by the control section 310. The communication section 330 transmits and receives data to and from another apparatus, under the control of the control section 310.

### <Flow of Electric Power Management Method Carried Out by Electric Power Management System 1D>

An electric power management method carried out by the electric power management system 1D can be similarly described by replacing “control apparatus 21C” with “control section 310” and replacing “display apparatus 23C” with “display section 340” in the description given on the flow of the electric power management method SIC with reference to FIG. 9.

### <Application Example>

For example, the present example embodiment is applicable in a case where a user is riding in the electric vehicle 20D, and is also applicable in a case where the user is not riding in the electric vehicle 20D, as described below. The user who is not riding in the electric vehicle 20D recognizes, on the terminal apparatus 30D, proposal information that proposes an advantage related to electrical discharging. This prompts the user to ride in the electric vehicle 20D and go to the charging and discharging facility 80 in the target area 90 to carry out electrical discharging of the electric vehicle 20D. Further, the user who is not riding in the electric vehicle 20D recognizes, on the terminal apparatus 30D, proposal information that proposes an advantage related to electrical charging. This prompts the user to ride in the electric vehicle 20D and go to the charging and discharging facility 80 in the target area 90 to carry out electrical charging of the electric vehicle 20D. Other points are similar to those of the application example in the fourth example embodiment.

### <Example Advantage of the Present Example Embodiment>

Thus, according to the present example embodiment, the user who is not riding in the electric vehicle 20D can be also prompted to carry out electrical charging and discharging of the electric vehicle 20D in accordance with the amount of electric power stored in the target area 90. This enables better control of the amount of electric power stored in the target area 90.

### [Variation 1]

The fourth and fifth example embodiments described above can each be modified such that the criterion D1 for determination related to the amount of electric power stored is changed in accordance with usage of the electric vehicle 20C or 20D. In the present variation, the changing section 12C changes, in accordance with the usage of the electric vehicle 20C or 20D, the criterion D1 for determination related to the amount of electric power stored.

For example, information indicative of usage of the electric vehicle 20C or 20D can be stored in a memory referred to by the control apparatus 21C in the electric vehicle 20C or 20D. In this case, the changing section 12C receives the information indicative of the usage from the control apparatus 21C and changes the criterion D1 for determination in accordance with the usage indicated by the received information.

Note here that the usage of the electric vehicle 20C or 20D is, for example, a frequency of use. The frequency of use can be a distance traveled, a time of traveling, or the like in a most recent predetermined period. Further, the frequency of use can be the number of days on which the electric vehicle 20C or 20D is caused to travel for at least a minimum traveling time (or by at least a minimum traveling distance) in the most recent predetermined period.

Further, changing the criterion D1 for determination can mean, for example, changing the threshold included in the criterion D1 for determination. For example, for an electric vehicle 20C or 20D having a high frequency of use (which, for example, is not less than a predetermined value), the changing section 12C causes the threshold included in the criterion D1 for determination to be lower than that for an electric vehicle 20C or 20D having a low frequency of use (which, for example, is less than the predetermined value). Further, for example, the changing section 12C can be configured to change the threshold such that the higher the frequency of use, the lower the threshold.

Thus, the present variation makes it possible to (i) reduce occasions to provide, to a user of the electric vehicle 20C or 20D having a high frequency of use, an advantage from carrying out electrical discharging and (ii) increase occasions to provide, to the user, an advantage from carrying out electrical charging. This enables an amount of electric power stored in the electric vehicle 20C or 20D having a high frequency of use to be maintained at a sufficient among in accordance with the frequency of use.

Further, the present variation makes it possible to (i) increase occasions to provide, to a user of the electric vehicle 20C or 20D having a low frequency of use, an advantage from carrying out electrical discharging and (ii) reduce occasions to provide, to the user, an advantage from carrying out electrical charging. This enables an amount of electric power stored in the electric vehicle 20C or 20D having a low frequency of use to be returned to the target area 90 and effectively used.

### [Variation 2]

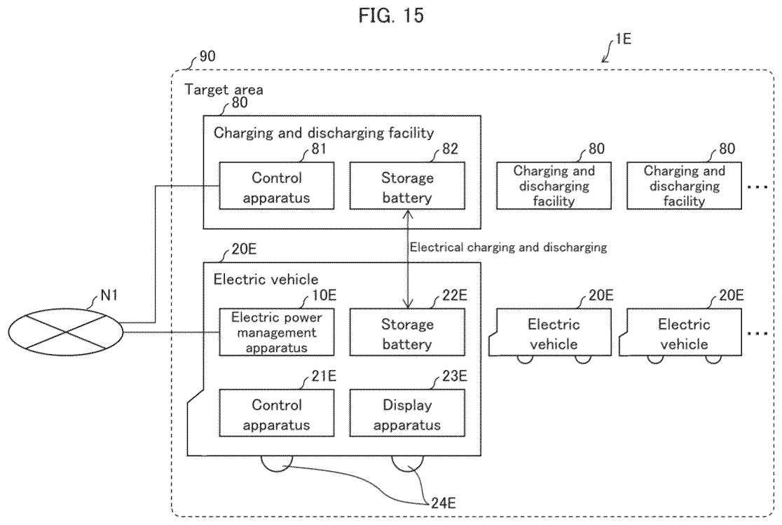

The fourth example embodiment described above can be modified such that an electric vehicle 20E equipped with an electric power management apparatus 10E is included in place of the electric power management apparatus 10C and the electric vehicle 20C. An electric power management system 1E in accordance with the present variation is described with reference to FIG. 15. FIG. 15 is a block diagram illustrating a configuration of the electric power management system 1E.

As illustrated in FIG. 15, the electric power management system 1E includes the electric power management apparatus 10E, the electric vehicle 20E, and a charging and discharging facility 80. The electric vehicle 20E includes the electric power management apparatus 10E, a control apparatus 21E, a storage battery 22E, a display apparatus 23E, and a conveyance mechanism 24E. The control apparatus 21E, the storage battery 22E, the display apparatus 23E, and the conveyance mechanism 24E are configured to be similar to the respective sections having the same names in the fourth example embodiment. The electric power management apparatus 10E and the electric vehicle 20E are communicatively connected to each other via, for example, an in-vehicle network, do not necessary have to be connected via the network N1. Other configurations are described to be similar to those of the fourth example embodiment. Note that, although FIG. 15 illustrates three electric vehicles 20E and three charging and discharging facilities 80, the number of electric vehicles 20E and the number of charging and discharging facilities 80 provided in the present variation are not limited to these numbers, and the present variation is not limited to a configuration in which the number of electric vehicles 20E is identical to the number of charging and discharging facilities 80. Further, each charging and discharging facility 80 is capable of electrical charging and discharging of any electric vehicle 20E.

### [Variation 3]

The first example embodiment described above can be modified such that (i) the changing section 12 is not included and (ii) the proposal information generation section 13A in the second example embodiment is included. In other words, an electric power management apparatus 10 in accordance with the present variation includes (i) a management section 11 that manages an amount of electric power stored in a target area and (ii) a proposal information generation section 13A that generates proposal information for a user of an electric vehicle in the target area in accordance with the amount of electric power stored, the proposal information pertaining to electrical charging or discharging of the electric vehicle. Further, an electric power management method S1 in accordance with the present variation includes the step S23 in accordance with the second example embodiment instead of including the step S12.

Thus, according to the present variation, it is expected that the user carries out, in accordance with proposal information presented in accordance with the amount of electric power stored, electrical charging or discharging of the electric vehicle in the target area. This brings about an advantage that it is possible to better control the amount of electric power stored in the target area in which an electric vehicle is electrically charged and discharged.

Note that similarly as the variation 3, the second and third example embodiments can each be modified such that the changing section 12A is not included. Also in this case, the respective example embodiments bring about an effect similar to the effect brought about by the variation 3.

### [Other Variations]

In the fourth example embodiment described above, the changing section 12C can make, with use of an inference model generated by machine learning, a determination as to whether or not the amount of electric power stored is sufficient. In this case, the criterion D1 for determination includes the inference model. The inference model can be a model which receives input of at least the amount of electric power stored in the target area 90 and outputs information indicative of whether or not the amount of electric power stored is sufficient or whether or not the amount of electric power stored is insufficient.

### [Software Implementation Example]

A part or all of the functions of the electric power management apparatus 10 and a part or all of the functions of the apparatuses constituting each of the electric power management systems 1A, 1B, 1C, 1D, and 1E may each be realized by hardware such as an integrated circuit (IC chip) or may each be alternatively realized by software.

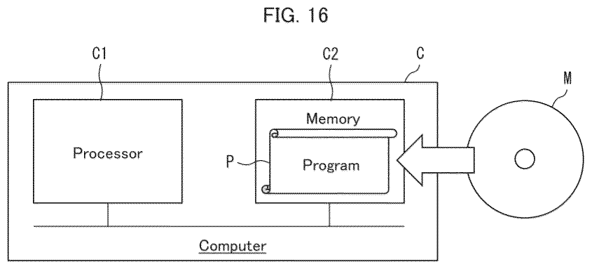

In the latter case, the electric power management apparatus 10 and the apparatuses constituting the electric power management systems 1A, 1B, 1C, 1D, and 1E are each realized by, for example, a computer that executes instructions of a program that is software realizing the functions. FIG. 16 illustrates an example of such a computer (hereinafter referred to as a “computer C”). The computer C includes at least one processor C1 and at least one memory C2. The memory C2 stores therein a program P for causing the computer C to operate as each of the electric power management apparatus 10 and the apparatuses constituting the electric power management systems 1A, 1B, 1C, 1D, and 1E. In the computer C, the functions of each of the electric power management apparatus 10 and the apparatuses constituting the electric power management systems 1A, 1B, 1C, 1D, and 1E are realized by the processor C1 reading the program P from the memory C2 and executing the program P.

The processor C1 can be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 can be, for example, a flash memory, a hard disk drive (HDD), a solid state drive (SSD), or a combination thereof.

Note that the computer C may further include a random access memory (RAM) in which the program P is loaded when executed and in which various data are temporarily stored. The computer C may further include a communication interface for carrying out transmission and reception of data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can be transmitted via a transmission medium. The transmission medium may be, for example, a communication network, a broadcast wave, or the like. The computer C can acquire the program P also via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

An electric power management apparatus, including:
a management means that manages an amount of electric power stored in a target area; and
a changing means that causes a parameter associated with a user of an electric vehicle in the target area to undergo a change in accordance with the amount of electric power stored.

### (Supplementary Note 2)

The electric power management apparatus described in supplementary note 1, further including a detection means that detects electrical charging or discharging of the electric vehicle in the target area,
the changing means causing the parameter associated with the user of the electric vehicle, the electrical charging or discharging of which has been detected, to undergo a change in accordance with the amount of electric power stored.

### (Supplementary Note 3)

The electric power management apparatus described in supplementary note 1 or 2, further including a proposal information generation means that generates proposal information for the user of the electric vehicle in the target area in accordance with the amount of electric power stored, the proposal information pertaining to electrical charging or discharging of the electric vehicle.

### (Supplementary Note 4)

The electric power management apparatus described in any one of supplementary notes 1 to 3, wherein the changing means
makes a determination as to whether or not the amount of electric power stored is sufficient, and in a case of determining that the amount of electric power stored is sufficient, causes the parameter to undergo a change in accordance with electrical charging of the electric vehicle.

### (Supplementary Note 5)

The electric power management apparatus described in any one of supplementary notes 1 to 4, wherein the changing means
makes a determination as to whether or not the amount of electric power stored is insufficient, and in a case of determining that the amount of electric power stored is insufficient, causes the parameter to undergo a change in accordance with electrical discharging of the electric vehicle.

### (Supplementary Note 6)

The electric power management apparatus described in supplementary note 4 or 5, wherein the changing means
changes, in accordance with usage of the electric vehicle, a criterion for the determination regarding the amount of electric power stored.

### (Supplementary Note 7)

The electric power management apparatus described in any one of supplementary notes 1 to 6, wherein the parameter is payment given or received by the user of the electric vehicle in the target area.

### (Supplementary Note 8)

An electric power management method, including:
managing an amount of electric power stored in a target area; and
causing a parameter associated with a user of an electric vehicle in the target area to undergo a change in accordance with the amount of electric power stored.

### (Supplementary Note 9)

A program for causing a computer to function as an electric power management apparatus, the program causing the computer to function as:
a management means that manages an amount of electric power stored in a target area; and
a changing means that causes a parameter associated with a user of an electric vehicle in the target area to undergo a change in accordance with the amount of electric power stored.

### (Supplementary Note 10)

An electric power management system, including an electric power management apparatus and an electric vehicle,
the electric power management apparatus including:
   a management means that manages an amount of electric power stored in a target area;
   a changing means that causes a parameter associated with a user of the electric vehicle in the target area to undergo a change in accordance with the amount of electric power stored; and
   a proposal information generation means that generates proposal information for the user in accordance with the amount of electric power stored, the proposal information pertaining to electrical charging or discharging of the electric vehicle,
the electric vehicle including a presentation means that presents the proposal information.

### (Supplementary Note 11)

An electric power management system, including an electric power management apparatus and a terminal apparatus,
the electric power management apparatus including:
   a management means that manages an amount of electric power stored in a target area;
   a changing means that causes a parameter associated with a user of the electric vehicle in the target area to undergo a change in accordance with the amount of electric power stored; and
   a proposal information generation means that generates proposal information for the user in accordance with the amount of electric power stored, the proposal information pertaining to electrical charging or discharging of the electric vehicle,
the terminal apparatus including a presentation means that presents the proposal information.

### (Supplementary Note 12)

An electric power management method, including:
managing an amount of electric power stored in a target area;
causing a parameter associated with a user of the electric vehicle in the target area to undergo a change in accordance with the amount of electric power stored;
generating proposal information for the user in accordance with the amount of electric power stored, the proposal information pertaining to electrical charging or discharging of the electric vehicle; and presenting the proposal information.

### [Additional Remark 3]

The whole or part of the example embodiments disclosed above can also be expressed as follows.

An electric power management apparatus, including at least one processor, the at least one processor carrying out: a management process of managing an amount of electric power stored in a target area; and a changing process of causing a parameter associated with a user of an electric vehicle in the target area to undergo a change in accordance with the amount of electric power stored.

Note that the electric power management apparatus may further include a memory, which may store therein a program for causing the at least one processor to carry out the management process and the changing process. The program can be stored in a computer-readable non-transitory tangible storage medium.

### REFERENCE SIGNS LIST

10, 10A, 10B, 10C, 10D, 10E: Electric power management apparatus
1A, 1B, 1C, 1D: Electric power management system
11, 11A, 11B, 11C: Management section
12, 12A, 12B, 12C: Changing section
13A, 13B, 13C: Proposal information generation section
14C: Detection section
20, 20A, 20C, 20D, 20E: Electric vehicle
21, 21C, 81: Control apparatus
21A, 31B: Presentation section
22, 22C, 82: Storage battery
23C: Display apparatus
24C: Conveyance mechanism
30, 30B, 30D: Terminal apparatus
80: Charging and discharging facility
90: Target area
110, 310: Control section
120, 320: Storage section
130, 330: Communication section

340: Display section
C1: Processor
C2: Memory

What is claimed is:

1. An electric power management apparatus, comprising at least one processor, the at least one processor carrying out:
a management process that manages an amount of electric power stored in a target area; and
a changing process that causes a parameter associated with a user of an electric vehicle in the target area to undergo a change in accordance with the amount of electric power stored.

2. The electric power management apparatus according to claim 1, the at least one processor further carries out a detection process that detects electrical charging or discharging of the electric vehicle in the target area,
in the changing process, the at least one processor causes the parameter associated with the user of the electric vehicle, the electrical charging or discharging of which has been detected, to undergo a change in accordance with the amount of electric power stored.

3. The electric power management apparatus according to claim 1, the at least one processor further carrying out a proposal information generation process that generates proposal information for the user of the electric vehicle in the target area in accordance with the amount of electric power stored, the proposal information pertaining to electrical charging or discharging of the electric vehicle.

4. The electric power management apparatus according to claim 1, wherein in the changing process, the at least one processor
makes a determination as to whether or not the amount of electric power stored is sufficient, and in a case of determining that the amount of electric power stored is sufficient, causes the parameter to undergo a change in accordance with electrical charging of the electric vehicle.

5. The electric power management apparatus according to claim 1, wherein in the changing process, the at least one processor
makes a determination as to whether or not the amount of electric power stored is insufficient, and in a case of determining that the amount of electric power stored is insufficient, causes the parameter to undergo a change in accordance with electrical discharging of the electric vehicle.

6. The electric power management apparatus according to claim 4, wherein in the changing process, the at least one processor
changes, in accordance with usage of the electric vehicle, a criterion for the determination regarding the amount of electric power stored.

7. The electric power management apparatus according to claim 1, wherein the parameter is payment given or received by the user of the electric vehicle in the target area.

8. An electric power management method, comprising:
managing an amount of electric power stored in a target area; and
causing a parameter associated with a user of an electric vehicle in the target area to undergo a change in accordance with the amount of electric power stored.

9. A non-transitory storage medium storing a program for causing a computer to function as an electric power management apparatus recited in claim 1, the program causing the computer to carry out the management process and the changing process.

10. An electric power management system, comprising an electric power management apparatus and an electric vehicle,
the electric power management apparatus including at least one first processor, the at least one first processor carrying out:
a management process that manages an amount of electric power stored in a target area;
a changing process that causes a parameter associated with a user of the electric vehicle in the target area to undergo a change in accordance with the amount of electric power stored; and
a proposal information generation process that generates proposal information for the user in accordance with the amount of electric power stored, the proposal information pertaining to electrical charging or discharging of the electric vehicle,
the electric vehicle including at least one second processor, the at least one second processor carrying out a presentation process that presents the proposal information.

11-12. (canceled)
